(19) United States
(12) Patent Application Publication
(10) Pub. No.: US 2012/0074848 A1
(43) Pub. Date: Mar. 29, 2012

(54) METHOD AND SYSTEM FOR MONITORING PERFORMANCE OF A DISCHARGE LAMP AND CORRESPONDING LAMP

(75) Inventors: Xiaoyan Zhu, Shanghai (CN); Georg Greuel, Aachen (DE); Levinus Pieter Bakker, Shanghai (CN); Cornelis Reinder Ronda, Aachen (DE); Thomas Juestel, Aachen (DE)

(73) Assignee: KONINKLIJKE PHILIPS ELECTRONICS N.V., Eindhoven (NL)

(21) Appl. No.: 13/376,223

(22) PCT Filed: Jun. 2, 2010
(86) PCT No.: PCT/IB2010/052451

§ 371 Date: Dec. 5, 2011

(30) Foreign Application Priority Data
Jun. 5, 2009 (CN) 200910142689.0

(51) Int. Cl. H01J 7/00; H01J 63/04

(52) U.S. Cl. 315/134; 313/485

(57) ABSTRACT

The present invention provides a method of monitoring performance of a discharge lamp. The discharge lamp includes electrodes and a discharge vessel filled with gas and equipped with a luminescent layer, wherein the gas is intended to emit a first ultraviolet light in a first spectral range when the gas is excited by an electric field produced by the electrodes, and at least part of the first ultraviolet light is intended to be changed into a second ultraviolet light in a second spectral range of longer wavelength than the first spectral range by the luminescent layer. The method comprises the steps of finding the value of a first intensity of the first ultraviolet light; finding the value of a second intensity of the second ultraviolet light; and determining the conversion efficiency of the luminescent layer for converting the first ultraviolet light into the second ultraviolet light on the basis of the ratio of the value of the second intensity to the value of the first intensity.

### FIELD OF THE INVENTION

The present invention relates generally to a method of monitoring performance of a discharge lamp, and, more particularly, to a method of monitoring performance of a discharge lamp for outputting ultraviolet light.

The present invention also relates to a system comprising a discharge lamp and being capable of being used to implement the method according to the invention.

### BACKGROUND OF THE INVENTION

For conventional ultraviolet (UV) lamps, visible light sensors are used to detect the intensity of visible spectral lines generated by plasma. The intensity of visible spectral lines is related to the UV light intensity inside the lamp. This provides a cost-effective detection system to monitor UV lamp performance. However, for UV dielectric barrier discharge (DBD) lamps or other, similar kinds of UV lamps, visible light sensors cannot be used to monitor such a kind of UV lamp performance, as there is no visible light emitted from the lamp.

The UV DBD lamp belongs to a relatively new family of UV lamps and is made up of a discharge vessel that is filled with gas and equipped with a luminescent layer, and electrodes that are electrically insulated from the gas by a dielectric barrier. The gas emits a first ultraviolet light predominantly in a first spectral range when the gas is excited by an electric field generated by the electrodes. At least part of the first ultraviolet light is then changed into a second ultraviolet light in a second spectral range of longer wavelength than the first spectral range by the luminescent layer. Usually, an ultraviolet sensor is used to detect the second ultraviolet light intensity of the lamp to monitor the UV lamp's performance. However, such an ultraviolet sensor is very expensive and cannot be used to identify the root-cause of the change of the second ultraviolet light intensity. The reason is that the second ultraviolet light intensity depends not only on the intensity of the first ultraviolet light, which is directly generated from the plasma of the gas after excitation of the gas by the electric field in the DBD lamp, but also on the luminescent layer conversion efficiency. As a result, the diagnosis of the lamp performance is not straightforward and reliable.

### SUMMARY OF THE INVENTION

It is an object of the present invention to provide a method and a system capable of monitoring performance of a discharge lamp.

In accordance with one aspect, the present invention provides a method of monitoring performance of a discharge lamp. The discharge lamp includes electrodes and a discharge vessel filled with gas and equipped with a luminescent layer, wherein the gas is intended to emit a first ultraviolet light in a first spectral range when the gas is excited by an electric field produced by the electrodes, and at least part of the first ultraviolet light is intended to be transformed into a second ultraviolet light in a second spectral range of longer wavelength than the first spectral range by the luminescent layer. The method comprises the steps of finding the value of a first intensity of the first ultraviolet light; finding the value of a second intensity of the second ultraviolet light; and determining the conversion efficiency of the luminescent layer for converting the first ultraviolet light into the second ultraviolet light on the basis of the ratio of the value of the second intensity to the value of the first intensity.

In accordance with another aspect, the present invention provides an irradiation system comprising a discharge lamp. The discharge lamp includes electrodes and a discharge vessel filled with gas and equipped with a luminescent layer, wherein the gas is intended to emit a first ultraviolet light in a first spectral range when the gas is excited by an electric field produced by the electrodes, and at least part of the first ultraviolet light is intended to be transformed into a second ultraviolet light in a second spectral range of longer wavelength than the first spectral range by the luminescent layer. The system further comprises a first monitoring unit and a second monitoring unit configured to find the values of a first intensity of the first ultraviolet light and a second intensity of the second ultraviolet light, respectively or cooperatively, and a control unit configured to determine the conversion efficiency of the luminescent layer for converting the first ultraviolet light into the second ultraviolet light on the basis of the ratio of the value of the second intensity to the value of the first intensity.

In accordance with yet another aspect, the present invention provides a discharge lamp for outputting ultraviolet light. The discharge lamp comprises electrodes and a discharge vessel filled with gas and equipped with a luminescent layer, wherein the gas is intended to emit a first ultraviolet light in a first spectral range when the gas is excited by an electric field produced by the electrodes, and at least part of the first ultraviolet light is changed into a second ultraviolet light in a second spectral range of longer wavelength than the first spectral range by the luminescent layer. The discharge lamp further comprises at least one substance selected from a first substance and a second substance. The first substance is adapted to convert at least part of the first ultraviolet light of the first and second ultraviolet light into a first visible light, and the second substance is adapted to convert at least part of the second ultraviolet light of the first and second ultraviolet light into a second visible light in a spectral range different from that of the first visible light.

The method and system of this invention result in a more reliable diagnosis of the discharge lamp and provide essential parameters indicative of the lamp performance, such as the first intensity for understanding the generation of the first ultraviolet light, which is mainly affected by the plasma condition and the electrode condition, and the conversion efficiency of the luminescent layer for evaluating luminescent layer degradation. Consequently, the change of the lamp performance can be judged and, more in particular, it can be determined whether this is caused by generation of the first ultraviolet light or degradation of the luminescent layer. By knowing the lamp performance from a view of these essential parameters, as illustrated below, users could actively adjust the electric power for driving the lamp when the change of the lamp performance is caused by the plasma, for example, or replace the lamp when the change of the lamp performance is caused by luminescent layer degradation, which means the lifetime of the lamp is nearing its end.

### BRIEF DESCRIPTION OF THE DRAWINGS

The above and other objects and features of the present invention will become apparent from the following detailed description of the various aspects in embodiments with reference to the accompanying drawings, in which

FIG. 1 is a schematic diagram of the self-diagnosing irradiation system according to the invention;

FIG. 2 is a first embodiment of part of the system according to the invention;

FIG. 3 is a second embodiment of part of the system according to the invention;

FIG. 4 is a third embodiment of part of the system according to the invention;

FIG. 5 is a flow chart of the method of diagnosing a discharge lamp according to the invention.

### BRIEF DESCRIPTION OF EMBODIMENTS

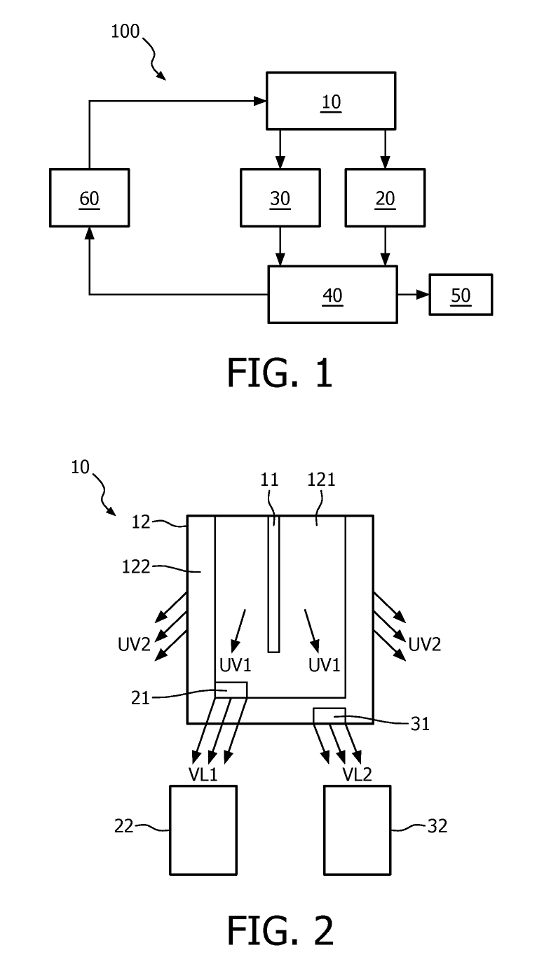

FIG. 1 is a schematic diagram of the self-diagnosing irradiation system 100 according to the invention. The system 100 comprises a discharge lamp 10, a first monitoring unit 20, a second monitoring unit 30, and a control unit 40.

As shown in FIG. 2, the discharge lamp 10 includes electrodes 11 and a discharge vessel 12 filled with gas 121 and equipped with a luminescent layer 122. It will be understood that the electrodes 11 shown in FIG. 2 and the following drawings are only a simple illustration, and for a detailed configuration reference is made to the prior art. At least part of the gas 121 is converted into plasma and emits a first ultraviolet light UV1 predominantly in a first spectral range when the gas 121 is excited by an electric field produced by the electrodes 11. At least part of the first ultraviolet light UV1 is then transformed into a second ultraviolet light UV2 in a second spectral range of longer wavelength than the first spectral range by the luminescent layer 122.

For example, such a discharge lamp 10 can be a UV DBD lamp. In this case, the first ultraviolet light is vacuum ultraviolet (VUV), and the second ultraviolet light can be ultraviolet A (UVA), ultraviolet B (UVB) or ultraviolet C (UVC).

Alternatively, the gas 121 contains xenon. In some embodiments, besides xenon, small additions of other noble gases, for instance, up to 5% of neon and/or 5% of helium are contained in the gas 121. The gas 121 can comprise other constituents except xenon, provided that when the gas 121 is excited by the electric field it can emit one kind of ultraviolet light of a comparatively short wavelength, at least part of which can be converted into another kind of ultraviolet light of a comparatively long wavelength by the luminescent layer 122.

The first monitoring unit 20 is configured to find the value of a first intensity of the first ultraviolet light UV1. The second monitoring unit 30 is configured to find the value of a second intensity of the second ultraviolet light UV2. Alternatively, the first monitoring unit and the second monitoring unit are configured to find the values of the first intensity of the first ultraviolet light and the second intensity of the second ultraviolet light cooperatively. Generally, the first monitoring unit 20 and the second monitoring unit 30 can have various configurations, which can form various combinations.

The control unit 40 is configured to determine the conversion efficiency of the luminescent layer for converting the first ultraviolet light into the second ultraviolet light on the basis of the ratio of the value of the second intensity to the value of the first intensity. The second intensity of the second ultraviolet light UV2 depends not only on the first intensity of the first ultraviolet light UV1, which is directly generated from the plasma of the gas after excitation of the gas by the electric field, but also on the conversion efficiency of luminescent layer 122. The second intensity is proportional to the first intensity and the conversion efficiency of the luminescent layer 122. Consequently, the conversion efficiency of the luminescent layer 122 can be determined on the basis of the ratio of the value of the second intensity to the value of the first intensity.

Alternatively, the control unit 40 is further configured to analyze performance of the discharge lamp 10 on the basis of the first intensity and the conversion efficiency of the luminescent layer 122. The changes of the first intensity, the second intensity and the conversion efficiency of the luminescent layer 122 can be easily found by a comparison of the individual parameters at different moments. The lamp lifetime is determined to a rather high extent by the operational lifetime of the luminescent layer, which embodies the change of the conversion efficiency of the luminescent layer 122 and is mainly caused by the luminescent layer degradation. Whether the lamp lifetime is nearing its end is proposed to be determined on the basis of the conversion efficiency of the luminescent layer 122. On the other hand, below a given conversion efficiency of the luminescent layer 122, the second intensity of the second ultraviolet light UV2 is determined by the first intensity, which is mainly determined by the plasma. The change in lamp performance, which apparently is embodied in the change of the second ultraviolet light UV2, can be judged as to whether it is caused by the plasma or the luminescent layer 122. This can facilitate the diagnosis of the lamp 10 via some essential parameters, so that the essential reason for the deterioration of the lamp performance can be found.

Alternatively, the control unit 40 is further configured to output a signal that is responsive to the first intensity for controlling the electric power to the lamp 10. In an embodiment, the system 100 further comprises a drive circuit unit 60 for providing electric power to the lamp 10 from a mains supply (not shown). The control unit 40 outputs the signal that is responsive to the first intensity to the drive circuit unit 60, and the drive circuit unit 60 then adjusts the electric power on the basis of this signal. Therefore, the control unit 40 can control the electric power to the lamp on the basis of the first intensity.

Alternatively, the control unit 40 is further configured to judge whether the lamp lifetime is nearing its end on the basis of the conversion efficiency of the luminescent layer 122, for example, by comparing the conversion efficiency of the luminescent layer 122 with a predetermined threshold conversion efficiency value indicative of satisfactory lamp performance. Furthermore, the control unit 40 is configured to output a signal indicative of end of life of the lamp 10 when the conversion efficiency of the luminescent layer 122 drops below the predetermined threshold conversion efficiency value.

Alternatively, the system 100 comprises a display unit 50 for displaying the above-mentioned parameters, such as the first intensity, the second intensity and the conversion efficiency of the luminescent layer, and/or the signals such as the signal indicative of end of life of the lamp.

Below, a more detailed description will be given of the first monitoring unit 20 and the second monitoring unit 30.

In an embodiment, as shown in FIG. 2, the first monitoring unit 20 comprises a first substance 21 and a first detector 22. The first substance 21 is adapted to convert at least part of the first ultraviolet light of the first and second ultraviolet light UV1 and UV2, respectively, into a first visible light VL1. The first detector 22 is adapted to measure the intensity of the first visible light VL1.

Alternatively, the sensitivity of the first substance 21 to the second ultraviolet light UV2 is approximately equal to zero, or the ratio of the sensitivity of the first substance 21 to the first ultraviolet light UV1 to the sensitivity of the first substance 21 to the second ultraviolet light UV2 is so large that the sensitivity of the first substance 21 to the second ultraviolet light UV2 is deemed to be zero. In other words, the first substance 21 is insensitive or very weakly sensitive to the second ultraviolet light UV2 and adapted to convert predominantly the first ultraviolet light UV1 into the first visible light VL1.

The second monitoring unit 30 comprises a second substance 31 and a second detector 32. The second substance 31 is adapted to convert at least part of the second ultraviolet light of the first and the second ultraviolet light UV1 and UV2, respectively, into a second visible light VL2. The second detector 32 is adapted to measure the intensity of the second visible light VL2.

Alternatively, the sensitivity of the second substance 31 to the first ultraviolet light UV1 is approximately equal to zero, or the ratio of the sensitivity of the second substance 31 to the second ultraviolet light UV2 to the sensitivity of the second substance 31 to the first ultraviolet light UV1 is so large that the sensitivity of the second substance 31 to the first ultraviolet light UV1 is deemed to be zero. In other words, the second substance 31 is insensitive or very weakly sensitive to the first ultraviolet light UV1 and adapted to convert predominantly the second ultraviolet light UV2 into the second visible light VL2.

The first and second visible light VL1 and VL2, respectively, have a different spectral range, which can be easily detected and distinguished by the first detector 22 and the second detector 32. The first detector 22 and the second detector 32 can be a common photodiode or photo-resistor and are equipped with an optical filter for transmitting only part of the radiation.

The intensities of the first and second visible light VL1 and VL2, respectively, are separately defined as I₁ and I₂, and the first and second intensities are separately defined as I_{UV1} and I_{UV2}. The first and second intensities can be separately determined on the basis of the intensities of the first and second visible lights VL1 and VL2. For example, the sensitivities of the first substance 21 to the first ultraviolet light UV1 and to the second ultraviolet light UV2 are defined as S₁₁ and S₁₂, respectively. The sensitivities of the second substance 31 to the first ultraviolet light UV1 and to the second ultraviolet light UV2 are defined as S₂₁ and S₂₂, respectively. Consequently, I₁ and I₂ can be expressed by the following equations: I₁=S₁₁×I_{UV1}+S₁₂×I_{UV2}, and I₂=S₂₁×I_{UV1}+S₂₂×I_{UV2}, respectively. As S₁₁, S₁₂, S₂₁ and S₂₂ are material properties of the first and the second substance, they can be determined once the first substance 21 and the second substance 31 are fixed; the intensities of the first and second ultraviolet light, I_{UV1} and I_{UV2}, can be derived from these two equations. To have the solution of I_{UV1} and I_{UV2} available, the relation of S₁₁, S₁₂, S₂₁ and S₂₂ needs to meet S₁₁×S₂₂ S₁₂×S₂₁, generally speaking, which means the ratio of the sensitivity S₂₁ for the first ultraviolet light to the sensitivity S₂₂ for the second ultraviolet light of the second substance 31 is different from the ratio of the sensitivity S₁₁ for the first ultraviolet light to the sensitivity S₁₂ for the second ultraviolet light of the first substance 21.

On the other hand, the second intensity is determined by the product of the first intensity and the conversion efficiency of the luminescent layer 122. Consequently, the conversion efficiency of the luminescent layer 122 can be determined on the basis of the ratio of the value of the second intensity and the value of the first intensity.

When S ₁₂=S₂₁=0, or S₁₂<<S ₁₁, S₂₁<<S₂₂, the intensity I₁ of the first visible lights VL1 has a direct proportion to the first intensities I_{UV1}, the intensity I₂ of the second visible lights VL2 has a direct proportion to the second intensities I_{UV2} In such a situation, the conversion efficiency of the luminescent layer can be also determined on the basis of a ratio of the value of the intensity I₂ of the second visible lights VL2 and the value of the intensity I₁ of the first visible lights VL1.

At a certain initial moment, such as any moment after the lamp 10 has been manufactured and before it is used, the intensities of the first and second visible lights VL1 and VL2 are measured and recorded as I₁(0) and I₂(0), respectively. Therefore, the initial first and second intensities can be determined on the basis of the intensities I₁(0) and I₂(0) of the first and second visible lights VL1 and VL2, respectively. Consequently, the initial conversion efficiency of the luminescent layer can be determined on the basis of the ratio of the initial second intensity and the initial first intensity, or on the basis of the ratio of the intensity I₂(0) and the intensity I₁(0) under the circumstances as described above.

At another moment t during use of the lamp 10, the intensities of the first and second visible lights VL1 and VL2 are measured and recorded as I₁(t) and I₂(t), respectively. Then, the first and second intensities at the moment t can be determined on the basis of the intensities I₁(t) and I₂(t) of the first and second visible lights VL1 and VL2, respectively. The conversion efficiency of the luminescent layer at the moment t can be determined on the basis of the ratio of the value of the second intensity and the value of the first intensity at the moment t.

Accordingly, the change of the first intensity can be easily found by comparison of the initial value of the first intensity and the value of the first intensity at the moment t; the change of the second intensity can be found by comparison of the initial value of the second intensity and the value of the second intensity at the moment t; the change of the conversion efficiency of the luminescent layer can be determined by comparison of the initial conversion efficiency and the conversion efficiency at the moment t.

In addition, when S₁₂=S₂₁=0, or S₁₂<<S₁₁, S₂₁<<S₂₂, the ratio h(t)/I₁(0) is an indication of the change of the first intensity of the first ultraviolet light UV1; the ratio I₂(t)/I₂(0) is an indication of the change of the second intensity of the second ultraviolet light UV2, that is also an indication of the changes of both the first intensity of the first ultraviolet light UV1 and the conversion efficiency of the luminescent layer. By comparison of the two ratios I₂(t)/I₁(t) and 1₂(0)/I₁(0), the change of the conversion efficiency of the luminescent layer can be determined.

As mentioned above, the lamp lifetime is determined to a rather high extent by the luminescent layer operational lifetime, which embodies the change of the conversion efficiency of the luminescent layer and is mainly caused by degradation of the luminescent layer. Consequently, whether the lamp lifetime is nearing its end can be determined on the basis of the conversion efficiency of the luminescent layer. For example, when comparing the conversion efficiency of the luminescent layer at the moment t with a predetermined threshold conversion efficiency value indicative of satisfactory lamp performance, once the conversion efficiency of the luminescent layer drops below the predetermined threshold conversion efficiency value, the lamp lifetime can be judged to be nearing its end accordingly. Or, when comparing the ratio of the conversion efficiency of the luminescent layer at the moment t and the initial conversion efficiency with a predetermined threshold value, once the ratio drops below the predetermined threshold value, the lamp lifetime can be judged to near to end accordingly.

On the other hand, below a certain conversion efficiency of the luminescent layer, the second intensity of the second ultraviolet light UV2 is determined by the first intensity, which is mainly decided by the plasma. Consequently, the lamp power can be controlled on the basis of the first intensity so as to meet the required intensity of the second ultraviolet light UV2.

The first substance 21 that is insensitive or very weakly sensitive to the second ultraviolet light UV2 comprises at least one composition selected from the group LaMgAl₁₁O₁₉:Gd, LaPO₄:Pr, LaPO₄:Ce, LuPO₄:Pr, YPO₄:Pr, YAlO₃:Pr, CaLi₂SiO₄:Pr,Na, (Y,Gd)BO₃:Tb, (Y,Gd)BO₃:Eu, (Y,Gd)BO₃:Ce, LaPO₄:Tm, YPO₄:Bi, Lu₃Al₅O₁₂:Pr, Lu₃Al₅O₁₂:Gd, and Lu₃Al₅O₁₂:Tm.

The first substance 21 can be located in a small region of the discharge vessel 12 and in direct contact with the plasma which is on top of the luminescent layer 122. The first substance 21 can also be admixed to the luminescent layer 122, and this means that the luminescent layer 122 also emits the first visible light VL1 which is used for diagnosis of the plasma.

The second substance 22 is insensitive or very weakly sensitive to the first ultraviolet light UV1; to some extent, this means that the second substance 22 should be protected against the plasma to avoid excitation from the plasma. There are many options for the second substance 22. In an embodiment, a substance containing Ca₃Lu₂Si₃O₁₂: Pr is an effective choice for the second substance 22. In this case, the second substance 22 can be located in another small region of the discharge vessel 12, i.e. between the wall of the discharge vessel 12 and the luminescent layer 122, and thus, the second substance 22 is excited by the luminescent layer 122 and protected against the plasma.

In another embodiment, the second substance 22 comprises a phosphor and a protective layer on top of the phosphor. The second substance 22 is placed between the wall of the discharge vessel 12 and the luminescent layer 122. The optical transmission of the protective layer on top of the phosphor can be chosen so that it can absorb the plasma emission but is transmissive for the emission of the luminescent layer 122. The bandgap of the protective layer is higher than the equivalent photon energy of the luminescent layer 122, but smaller than the photon energy of the first ultraviolet light from the plasma radiation. In yet another embodiment, the second substance 22 comprises a plurality of phosphor grains and a plurality of particle coatings on each phosphor grain respectively. The requirement to be met by the protective layer in the previous embodiment also applies to the particle coating. In such embodiments, the phosphor contained in the second substance 22 can be any type of phosphor that can convert ultraviolet light of a rather long wavelength into visible light, such as BaMgAl₁₀O₁₇:Eu, Zn₂SiO₄:Mn or Y₂O₃:Eu. The effective composition contained in the protective layer or the particle coating can be at least one selected from the group of ZrO₂, Y₂O₃, La₂O₃, or Gd₂O₃

Alternatively, the first and second substances 21 and 22 each separately comprise phosphor. Preferably, the first and second substances 21 and 22 have a high stability, which means that the first and second substances 21 and 22 do not degrade over their lifetime or their degradation rates are far smaller than that of the luminescent layer, so that the degradation of the first and second substances 21 and 22 can be ignored. As regards the location of both substances, there may be more ways of placing the first and second substance 21 and 22, depending on the material properties and lamp manufacturing process.

In this embodiment, by using the first substance 21 and the second substance 22, which respectively convert part of the ultraviolet lights of different wavelength into visible lights of different wavelength, the intensities of ultraviolet lights of different wavelength generated from the lamp are easily attained by measuring the intensities of corresponding visible lights via a less expensive visible light detector. Compared with the rather expensive ultraviolet detector to directly measure the intensities of ultraviolet lights, such an indirect monitor means used with the help of the first substance 21 and the second substance 22 has the advantage of saving costs. Furthermore, such an indirect monitor means can be used more widely, compared with the direct measurement via an ultraviolet detector, because ultraviolet light to be captured by the ultraviolet detector is easily affected by where the lamp is located, which limits the application of the ultraviolet detector.

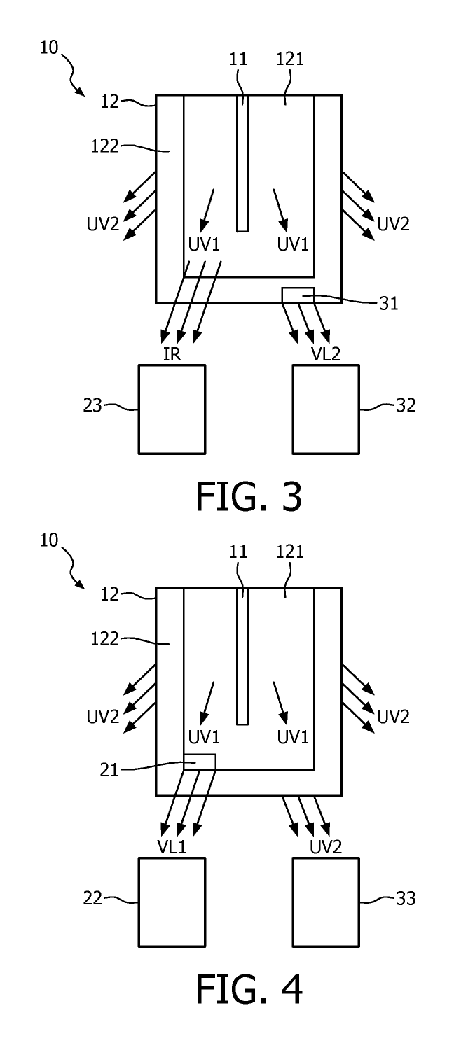

FIG. 3 is a second embodiment of part of the system 100 according to the invention. As shown in FIG. 3, the first monitoring unit 20 comprises a detector 23 for measuring the intensity of infrared light (IR) emitted from the gas 121 and a calculating device (not shown in the drawings) for determining the first intensity on the basis of the intensity of IR, which has a certain correlation with the first intensity. Alternatively, the calculating device can be combined with the control unit 40 or its function can be performed by manpower.

IR intensity and the first intensity of the first ultraviolet light UV1 at different lamp input powers can be pre-calibrated and formed into a lookup table. In real use, by measuring the IR intensity via the detector 23, which can be a normal photodiode, the first intensity I_{UV1} can be determined accordingly, based on the look up table.

The second monitoring unit 30 comprises a second substance 31 and a second detector 32, which have the same configurations and functions as those in the first embodiment of the system, respectively. Thus, the intensity I₂ of the second visible light VL2 is directly measured by means of the second detector 32. Based on the equation I₂=S₂₁×I_{UV1}+S₂₂×I_{UV2}, as S₂₁ and S₂₂ can be determined once the second substance 31 is fixed and the first intensity I_{UV1} is attained by the first monitoring unit 20, the second intensity I_{UV2} of the second ultraviolet light UV2 is derived from this equation.

If the second substance 31 is selected to be insensitive or very weakly sensitive to the first ultraviolet light UV1, then S₂₁ can be deemed to be zero; as a result, the second intensity I_{UV2}of the second ultraviolet light UV2 is directly proportional to the second intensity I₂ of the second visible lights VL2 and can be directly attained on the basis of the second intensity I₂ of the second visible lights VL2.

The conversion efficiency of the luminescent layer is then determined on the basis of the ratio of the second intensity I_{UV2} to the first intensity I_{UV1}. Alternatively, the conversion efficiency of the luminescent layer can be also determined on the basis of the ratio of the intensities of the second visible light VL2 and IR if the second substance 31 is selected to be insensitive or very weakly sensitive to the first ultraviolet light UV1. Consequently, as regards the change of the second ultraviolet light UV2 (lamp performance), it can be determined whether it is caused by the first ultraviolet light UV1 or the luminescent layer. This can facilitate the diagnosis of the lamp, considering the plasma and the luminescent layer. The conversion efficiency of the luminescent layer also gives the lamp lifetime information.

FIG. 4 is a third embodiment of part of the system according to the invention. The first monitoring unit 20 comprises a first substance 21 and a first detector 22, which have the same configurations and functions as those in the first embodiment of the system, respectively. Thus, the intensity I₁ of the first visible light VL1 is directly measured by means of the first detector 22.

The second monitoring unit 30 comprises an ultraviolet detector 33 for measuring the second intensity I_{UV2} of the second ultraviolet light UV2. As the second ultraviolet light UV2 has a rather long wavelength, such an ultraviolet detector 33, which can directly measure the intensity of the second ultraviolet light UV2 from the lamp itself, is commercially available. For example, when the second ultraviolet light UV2 is UVC, a UVC sensor can be easily bought from the market.

Based on the equation I₁=S₁₁×I_{UV1}+S₁₂×I_{UV2}, as S₁₁ and S₁₂ can be determined once the first substance 21 is fixed and the second intensity I_{UV2} is attained by the second monitoring unit 30, the first intensity I_{UV1} of the first ultraviolet light UV1 is derived from this equation.

If the first substance 21 is selected to be insensitive or very weakly sensitive to the second ultraviolet light UV2, then S₁₂ can be deemed to be zero; as a result, the first intensity I_{UV1} of the first ultraviolet light UV1 is directly proportional to the intensity I1 of the first visible lights VL1 and can be directly attained on the basis of the intensity I1 of the first visible lights VL1. Consequently, the first intensity I_{UV1} of the first ultraviolet light UV1 is obtained by means of the first monitoring unit 20.

Based on the same principle, the conversion efficiency of the luminescent layer is determined on the basis of the ratio of the second intensity I_{UV2}and the first intensity I_{UV1}.

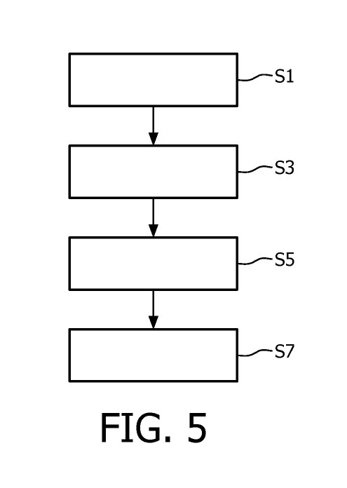

FIG. 5 is a flow chart of a method 600 of monitoring performance of a discharge lamp according to the invention. For easy understanding, an example of the method 600 will now be given in combination with the irradiation system 100 described above. First, in step S1, the value of a first intensity of the first ultraviolet light is attained by means of the first monitoring unit 20. In step S3, the value of a second intensity of the second ultraviolet light is attained via the second monitoring unit 30. Alternatively, for different purposes and/or requirements, step S1 and step S3 may be done repeatedly with an interval or without interruption. Alternatively, for each time, step S1 and step S3 can be done at the same time or consecutively within a reasonable period and there is no special order requirement. Consequently, the conversion efficiency of the luminescent layer for converting the first ultraviolet light into the second ultraviolet light is determined on the basis of the ratio of the value of the second intensity to the value of the first intensity (step S5). It can be understood that the values of the first intensity and the second intensity may vary from time to time; therefore, the conversion efficiency of the luminescent layer at a certain moment or within a reasonable period is determined by the values of the first intensity and the second intensity that are attained at the same time or within the reasonable period. Once these essential parameters including the first intensity, the second intensity and the conversion efficiency of the luminescent layer are attained, the performance of the lamp can be analyzed on the basis of the first intensity and the conversion efficiency of the luminescent layer so as to find the essential reasons that affect the lamp performance (step S7). In step S7, the analysis can be automatically done by the control unit 40 or by manpower. For more details about the method 600, reference is made to the description of system 100.

The embodiments described above are merely preferred embodiments of the present invention. Other variations of the disclosed embodiments can be understood and effected by those skilled in the art in practicing the claimed invention, from a study of the drawings, the disclosure, and the appended claims. These variations shall also be considered to be within the scope of the present invention. In the claims and description, use of the verb “comprise” and its conjugations does not exclude other elements or steps, and the indefinite article “a” or “an” does not exclude a plurality.

1. A method of monitoring performance of a discharge lamp, the discharge lamp including electrodes and a discharge vessel filled with gas and equipped with a luminescent layer, wherein the gas is intended to emit a first ultraviolet light in a first spectral range when the gas is excited by an electric field produced by the electrodes, at least part of the first ultraviolet light being intended to be changed into a second ultraviolet light in a second spectral range of longer wavelength than the first spectral range by the luminescent layer, said method comprising the steps of:
finding the value of a first intensity of the first ultraviolet light;
finding the value of a second intensity of the second ultraviolet light; and
determining the conversion efficiency of the luminescent layer for converting the first ultraviolet light into the second ultraviolet light on the basis of the ratio of the value of the second intensity to the value of the first intensity.

2. A method according to claim 1, wherein the step of finding the value of the first intensity comprises measuring the intensity of infrared light emitted from the gas and determining the first intensity on the basis of the intensity of infrared light, which has a certain correlation with the first intensity.

3. A method according to claim 1, wherein the step of finding the value of the first intensity comprises using a first substance to convert at least part of the first ultraviolet light of the first and second ultraviolet light into a first visible light and measuring the intensity of the first visible light.

4. A method according to claim 3, wherein the sensitivity of the first substance to the second ultraviolet light is approximately equal to zero, or the ratio of the sensitivity of the first substance to the first ultraviolet light to the sensitivity of the first substance to the second ultraviolet light is so large that the sensitivity of the first substance to the second ultraviolet light is deemed to be zero.

5. A method according to claim 1, wherein the step of finding the value of the second intensity comprises measuring the second intensity by means of an ultraviolet detector.

6. A method according to claim 1, wherein the step of finding the value of the second intensity comprises using a second substance to convert at least part of the second ultraviolet light of the first and second ultraviolet light into a second visible light and measuring the intensity of the second visible light.

7. A method according to claim 6, wherein the sensitivity of the second substance to the first ultraviolet light is approximately equal to zero, or the ratio of the sensitivity of the second substance to the second ultraviolet light to the sensitivity of the second substance to the first ultraviolet light is so large that the sensitivity of the second substance to the first ultraviolet light is deemed to be zero.

8. A method according to claim 3, wherein the step of monitoring the second intensity comprises using a second substance, of which the ratio of the sensitivity to the first ultraviolet light to the sensitivity to the second ultraviolet light is different from the ratio of the sensitivity to the first ultraviolet light to the sensitivity to the second ultraviolet light of the first substance, to convert at least the second ultraviolet light of the first and second ultraviolet light into a second visible light and measure the intensity of the second visible light.

9. A method according to claim 8, wherein the sensitivity of the first substance to the second ultraviolet light is approximately equal to zero, or the ratio of the sensitivity of the first substance to the first ultraviolet light to the sensitivity of the first substance to the second ultraviolet light is so large that the sensitivity of the first substance to the second ultraviolet light is deemed to be zero; the sensitivity of the second substance to the first ultraviolet light is approximately equal to zero, or the ratio of the sensitivity of the second substance to the second ultraviolet light to the sensitivity of the second substance to the first ultraviolet light is so large that the sensitivity of the second substance to the first ultraviolet light is deemed to be zero; and the step of determining the efficiency of the luminescent layer comprises calculating the ratio of the intensity of the second visible light to the intensity of the first visible light, which has a certain correlation with the ratio of the second intensity to the first intensity.

10. A method according to claim 4, wherein the first substance comprises at least one composition selected from the group of LaMgAl₁₁O₁₉:Gd, LaPO₄:Pr, LaPO₄:Ce, LuPO₄:Pr, YPO₄:Pr, YAlO₃:Pr, CaLi₂SiO₄:Pr,Na, (Y,Gd)BO₃:Tb, (Y,Gd)BO₃:Eu, (Y,Gd)BO₃:Ce, LaPO₄:Tm, YPO₄:Bi, Lu₃Al₅O₁₂:Pr, Lu₃Al₅O₁₂:Gd, and Lu₃Al₅O₁₂:Tm.

11. A method according to claim 7, wherein the second substance comprises Ca₃Lu₂Si₃O₁₂:Pr, or comprises a phosphor with a particle coating adapted to absorb the first ultraviolet light.

12. A method according to claim 1, wherein the first ultraviolet light is vacuum ultraviolet, and the second ultraviolet light comprises at least one selected from ultraviolet A, ultraviolet B and ultraviolet C.

13. A method according to claim 1, wherein the method further comprises the step of analyzing performance of the discharge lamp on the basis of the first intensity and the conversion efficiency of the luminescent layer.

14. A method according to claim 13, wherein the analyzing step comprises determining whether the lamp lifetime is nearing its end on the basis of the conversion efficiency of the luminescent layer, and/or adjusting the electric power to the lamp on the basis of the first intensity.

15. A discharge lamp for outputting ultraviolet light, the discharge lamp comprising:
electrodes;
a discharge vessel filled with gas and equipped with a luminescent layer, wherein the gas is intended to emit a first ultraviolet light in a first spectral range when the gas is excited by an electric field produced by the electrodes, and at least part of the first ultraviolet light is intended to be changed into a second ultraviolet light in a second spectral range of longer wavelength than the first spectral range by the luminescent layer; and
at least one substance selected from a first substance and a second substance, the first substance being adapted to convert at least part of the first ultraviolet light of the first and second ultraviolet light into a first visible light, the second substance being adapted to convert at least part of the second ultraviolet light of the first and second ultraviolet light into a second visible light in a spectral range different from that of the first visible light.

16. An irradiation system comprising:
a discharge lamp including electrodes and a discharge vessel filled with gas and equipped with a luminescent layer, wherein the gas is intended to emit a first ultraviolet light in a first spectral range when the gas is excited by an electric field produced by the electrodes, and at least part of the first ultraviolet light is intended to be transformed into a second ultraviolet light in a second spectral range of longer wavelength than the first spectral range by the luminescent layer;
a first monitoring unit and a second monitoring unit configured to find the values of a first intensity of the first ultraviolet light and a second intensity of the second ultraviolet light, respectively or cooperatively; and
a control unit configured to determine the conversion efficiency of the luminescent layer for converting the first ultraviolet light into the second ultraviolet light on the basis of the ratio of the value of the second intensity to the value of the first intensity.
